(19) United States
(12) Patent Application Publication
(10) Pub. No.: US 2010/0124599 A1
(43) Pub. Date: May 20, 2010

(54) REDUCED SUGAR ICE CONFECTION

(75) Inventors: Joumana Saikali, Beauvais (FR); Anne-Cecile Agnes Lebleu, Beauvais (FR); Myriam Schlegel, Fouquenies (FR)

Correspondence Address: K&L Gates LLP, P.O. Box 1135, CHICAGO, IL, 60690, US

(73) Assignee: Nestec S.A., Vevey (CH)

(21) Appl. No.: 12/595,915

(22) PCT Filed: Apr. 10, 2008
(86) PCT No.: PCT/EP2008/054366

§ 371 Date: Oct. 14, 2009

(30) Foreign Application Priority Data
Apr. 17, 2007 (EP) 07106351.5

(51) Int. Cl. A23G 9/34

(52) U.S. Cl. 426/660

(57) ABSTRACT

The present invention describes an ice confection composition having a reduced sugar content, which comprises a sugar mixture containing fructose and sucrose.

### FIELD OF THE INVENTION

Ice confections are products which are highly appreciated by consumers, both children and adults. Sweetness is a major driver for consumer preference. Another important feature is the texture of the ice confections. The consumers expect them to be easily scoopable or directly edible from the freezer.

There has been an increasing concern for health and wellness and an increasing need for reducing calories, sugars and fats also in ice confections. A joint FAO/WHO Expert Consultation recommended that excessive intakes of sugars which compromise micronutrient density should be avoided. The bulk of carbohydrate-containing foods consumed should be those rich in non-starch polysaccharides and with a low glycemic index. (Carbohydrates in human nutrition. 1998 FAO Food and Nutrition Paper-66) Similarly, the French Food & Safety Agency AFSSA emitted recommendations to decrease added sugar intake and favour consumption of unrefined carbohydrates, especially in children diets. (Carbohydrates & Health: current situation, evaluation & recommendations, AFSSA October 2004).

Hitherto, many ice confections have been put on the market that claim low or no sugar by containing polyols and/or intense sweeteners. However, polyols may have laxative effects when consumed at high levels and use of intense sweeteners is not recommended for products aimed at young children. In addition, consumers associate ice confections with indulgence and seek for themselves and their children nutritionally more balanced products.

### BACKGROUND OF THE INVENTION AND RELATED PRIOR ART

It is common knowledge that sugars play an essential role in the sensory properties of ice confections. Sugars have at least a dual function in ice confections. They provide sweetness and flavor enhancement and depress the freezing point making the ice confection conveniently scoopable. In addition, sugars are a cheap source of solids.

Reducing total sugars in ice confections thus implies contemplating the loss of these properties and therefore, the need to find a way of preventing the ice confection from getting exceedingly hard and untasty. This is generally performed by using polyols and/or intense sweeteners.

All sugars do not have the same sweetening power and freezing point depression factor. Usually, monosaccharides such as glucose, galactose or fructose depress the freezing point more than disaccharides like maltose, lactose, sucrose.

Fructose is unanimously considered as sweeter than sucrose. Its sweetening power in water is estimated to 120-150 compared to a 10% sucrose reference of a sweetening power of 100. A value of 173 is described in “Ice Cream”, sixth edition (R. T. Marshall, H. Douglas Goff and R. W. Hartel). In addition, the fructose sweetness is known to be different in temporal profile by having a quicker onset and a shorter lasting than that of sucrose which is the sugar considered as giving the most pleasant sweetness.

U.S. Pat. No. 4,497,841 describes ice cream dessert mixes containing, as a sweetening agent, a fructose-based sweetener containing at least 75% by weight of fructose. In a preferred embodiment the ice confection is free of sucrose and contains pure fructose because of the said high sweetness of this sugar. The ice creams described in this patent comprise fructose in a very high amount which may have an adverse impact on the consumer's health.

EP 0 244 149 B1 teaches that some specific ratios of sucrose and fructose have exhibited synergistic effects in sweetness. However, there is no specific application in ice cream production described.

EP 1 673 980 A1 provides a low-calorie frozen confection comprising fructose in combination with other saccharides as a sweetening agent. The confection contains considerable amounts of digestible complex saccharides to compensate for the relative low levels of sugars, which may not offer a nutritional benefit compared to the sugars replaced. In fact the total amount of digestible carbohydrates remains the same or is increased; therefore the energy contribution as well as the impact on glycemia would not be better than full sugar similar products. Additionally this invention does not mention the need for a minimum amount of sucrose to provide a pleasant taste.

Therefore, it is an object of the invention to provide reduced sugar ice confections with a pleasant taste and texture without using polyols or intense sweeteners.

It is a further object of the invention to provide reduced sugar ice confections having a sufficient sweetness while limiting the amounts of fructose contained therein.

It is a further object of the present invention to provide an ice confection which has a pleasant sweet taste and texture, and which addresses the existing demand for products free of non-nutritive sweeteners such as intense sweeteners and potentially laxative sugar alcohols.

### SUMMARY OF THE INVENTION

These objects have been solved with an ice confection composition free of intense sweetener, having a reduced sugar content of not exceeding 15 wt.-% based on the total composition, which comprises

a. a mixture of sugars containing fructose and at least 1 wt.-% of sucrose based on the total composition, wherein the amount of fructose is up to 80% of the total sugars,

b. a level equal or less than 8 wt.-% of non-fat milk solids,

c. less than 7 wt.-% of medium to high glycemic index oligosaccharides and/or polysaccharides,

d. at least one galactomannan stabilizer, and

e. less than 2% polyol.

This ice confection composition is, for example, suitable for preparing a water ice, sorbet or an ice cream.

Unless otherwise specified, wt.-% are expressed based on the weight of the total composition.

These objects have also been solved with an ice confection composition free of intense sweetener, having a reduced sugar content of not exceeding 15 wt.-% based on the total composition, which comprises

a. a mixture of sugars containing fructose and at least 1 wt.-% of sucrose based on the total composition, wherein the amount of fructose is up to 75% of the added sugars,

b. more than 8 wt.-% of non-fat milk solids,

c. less than 7 wt.-% of medium to high glycemic index oligosaccharides and/or polysaccharides, and

d. less than 2% polyol.

This ice confection may be used, for example, for preparing an ice cream.

The subclaims define preferred embodiments of the subject matter claimed.

It has been found that the ice confection composition of the present invention possesses many valuable and attractive properties to the consumers. It has been found, for example, that a reduced sugar ice confection according to the invention with less than 2% polyols, preferably without any polyol nor intense sweeteners, as well as the products containing it, have a pleasant texture and sweetness. Advantageously, the products containing the composition of the invention have an improved sweetness and taste even though a substantial amount of the conventional sugars has been eliminated. It has been found that, contrary to prior knowledge in other areas than ice confection, fructose does not express a higher sweetening power than the equivalent weight of sucrose when used in combination with very low levels of sucrose in ice confection products. In the prior art, the high relative sweetness of fructose is described and minimum levels of this sugar to produce sweet ice confections are required. Surprisingly, a minimum level of sucrose in combination with fructose was found to achieve an optimised pleasant sweetness in reduced sugar ice confections.

In the present invention, ranges of sugar combinations have been determined to express sugar synergies and allow developing a tasty ice confection. An additional benefit to the good sweetness intensity due to the claimed sugar combination, is a pleasant temporal profile of sweetness.

In the following, the terms used herein are explained.

As used herein, the term “sugar” refers to digestible mono- and disaccharides having a caloric value of >3.5 kcal/g. Non-limiting examples are dextrose, sucrose, lactose, maltose and fructose.

The term “added sugars” refers to all sugars added to the ice confection by the manufacturer plus sugars naturally present in honey, syrups and fruit juices. It excludes sugars naturally present in the milk ingredients (such as lactose) or coming from the fruit.

The term “oligosaccharides” means carbohydrates having a degree of polymerization between 3 and 9.

The term “polysaccharides” means carbohydrates having a degree of polymerization of more than 10.

The term “medium to high glycemic index (GI) oligosaccharides and/or polysaccharides” refers to oligosaccharides and/or polysaccharides having a GI of >55 compared to glucose. They have a caloric value of >3.5 kcal/g.

The term “low glycemic index (GI) oligosaccharides and/or polysaccharides” refers to oligosaccharides and/or polysaccharides having a GI of <55 compared to glucose. They have a caloric value of >3.5 kcal/g.

“Non-digestible carbohydrates” in the sense of the present invention have a caloric value of <3.5 kcal/g.

The term “ice confection” encompasses sweet foodstuffs intended to be consumed in frozen state. Typical examples are ice creams, water ices and sorbets.

The term “non-fat milk solids” as used herein, refers to non-fat dry milk, dry buttermilk, whey, caseinate, low lactose skim milk powder and mixtures thereof.

The “relative sweetness” of a given sugar A is represented by the formula

C_{S}/C_{A}

wherein C_{S} means the concentration of sucrose providing a perceived sweetness intensity I and C_{A} is the concentration of the sugar A to get the same intensity I.

### DETAILED DESCRIPTION OF THE INVENTION

The ice confection composition of the present invention has a reduced sugar content of not exceeding 15% based exclusively on natural sugars. The ice confection composition comprises a mixture of sugars containing fructose and at least 1 wt.-% of sucrose based on the total composition.

The ice confection of the present invention contains less than 2% of polyols and is free of intense sweetener (also called high intensity sweeteners). More preferably, the ice confection of the present invention does not contain any polyol or intense sweetener.

In a first embodiment, an ice confection of the invention comprises a level equal or less than 8 wt.-% of non-fat milk solids, less than 7 wt.-% of medium to high glycemic index oligosaccharides and/or polysaccharides and the amount of fructose is up to 80% of the total sugars. In a preferred embodiment of the invention, the amount of fructose is less than 75% of the total sugars. An ice confection according to the first embodiment of the invention further contains galactomannans as stabilizers. Typical examples are guar and locust bean gum. It has been shown that these stabilizers contribute to provide a good mouthfeel and smoothness to the ice confection.

In a second embodiment, an ice confection of the invention comprises more than 8 wt.-% of non-fat milk solids and less than 7 wt.-% of medium to high glycemic index oligosaccharides and/or polysaccharides when the amount of fructose is up to 75% of the added sugars.

According to any embodiment of the invention, surprisingly and contrary to prior knowledge in other areas than ice confections, fructose shows in the compositions according to the invention a higher sweetening power than sucrose only when used in combination with at least 1 wt.-%, preferably 2 wt% sucrose of the total composition.

Preferably, the amount of fructose in the ice confection composition of the present invention is in a range of 2 to 10 wt.-% based on the total composition. More preferably, the amount of fructose is in the range of 4 to 8 wt.-% based on the total composition. It has been shown that best sweetening results can be achieved when the amount of fructose is at least 2 wt.-% based on the total composition.

Optimum results with respect to the sweetening power can be obtained, for example, when at least 2 wt.-% fructose and at least 1 wt.-% sucrose are contained in the ice confection composition of the present invention. It has been surprisingly shown that a higher sweetness than the equivalent amount of total sugars coming from fructose or sucrose used alone can be achieved.

In addition, using the claimed combination of fructose, sucrose in the said amounts and potentially other sugars in ice confections provides for a scoopable and good texture product well accepted by the consumer.

The ice confection composition of the present invention can also comprise other ingredients which are usually added to ice confection products.

The ice confection composition may also contain mono- and/or disaccharides other than fructose and sucrose.

The ice confection composition of the present invention is preferably characterized by a low fat content. In a particular embodiment, the fat content is no more than 7 wt.-% based on the total composition. Usually, the fat ingredients can be selected from butter fat, cream, cocoa butter, coconut oil, palm oil, palm kernel oil, sunflower oil, safflower oil rapeseed oil, or soybean oil and fractions or mixtures thereof.

If desired, the ice confection composition of the present invention can further comprise digestible low glycemic index oligosaccharides or polysaccharides. The amount of the digestible low glycemic index oligosaccharides or polysaccharides is no more than 20 wt.-% based on the total weight of the composition.

Non-limiting examples of the low glycemic index oligo-saccharides or polysaccharides are slowly digestible starches and derivatives.

If appropriate, the ice confection composition of the present invention further comprises non-digestible carbohydrates acting as bulking agent. The non-digestible carbohydrates can be selected from inulin, fructo-oligo-saccharides, galacto-oligo-saccharides, polydextrose, dextrins, resistant starch, fibers from vegetal origin and mixtures thereof. In a preferred embodiment, the non-digestible bulking agents comprise fibres extracted from vegetal origin.

The amount of the non-digestible bulking agent is preferably in a range of 1 to 15 wt.-% based on the total composition.

The ice confection composition of the present invention may further comprise ingredients and/or additives which are common in ice cream domain. Said ingredients and/or additives are, for example, proteins, emulsifiers, stabilizers, acidifying agents, flavourings, colourings and mixtures thereof.

The proteins to be used in the ice cream composition of the present invention are, for example, milk proteins or proteins from milk origin, egg proteins or proteins from vegetable origin such as soya, rice, pea, wheat and oat.

Suitable but non-limiting examples of emulsifiers to be used are monoglycerides, diglycerides, polysorbate, or polyol esters of fatty acids such as propylene glycol monoester of fatty acids and mixtures thereof.

Stabilizers which can be used in the present invention are locust bean gum, guar gum, alginates, cellulose, xanthan gum, carboxymethyl cellulose, microcrystalline cellulose, alginates, carrageenans, pectins and mixtures therof.

Having at least a stabilizer from the group of galactomannans such as locust bean gum and guar, was seen to be useful to provide a pleasant texture and heat shock stability.

The choice of amounts thereof is within the skill of a skilled person in the art.

If the ice confection composition of the present invention is intended to exhibit a particular fruity character, it may also comprise fruit puree, fruit pieces or juices of any suitable fruit.

The ice confection composition of the present invention also contains essential amounts of water but still exhibit good sensory properties and heat shock and melting resistance. Preferably, the water content is in the range of 55 to 95 wt.-%, more preferably 65 to wt.90% of the total composition. Depending on the water content and the ingredients employed in the ice confection composition, the ice confection composition of the present invention can be composed as an ice cream, sorbet or water ice which can be kept frozen at temperatures between −10° to −35° C. and consumed at said temperatures.

In a preferred embodiment of the invention, the ice confection has an overrun in the range of 0 to 200%, when formulated as a water ice or sorbet. An ice cream product usually has an overrun in the range of 20 to 250%.

The energy values of the ice confection compositions of the invention are quite low, preferably in a range of 40 to 160 kcal/100 g.

The ice confections according to the invention are manufactured following standard processes. Usually, the ingredients are mixed in an appropriate mixer and subsequently pasteurized and homogenized or vice versa. The homogenized/pasteurized mixture is then optionally aged. The mix is than aerated until an appropriate overrun and frozen to a temperature of around −1 to −20° C. The ice confection produced may then be hardened to a temperature between −20° to −40° C. for several hours. The ice confections are then stored at an appropriate freezing temperature of around 20 to −35° C.

The present invention is now further illustrated by means of the examples.

### EXAMPLES

### Example 1

The following ice confection has been prepared using the following ingredients:

Formula 1
Units (% wt of the total composition)

| | |
|---|---|
| water | 58.90 |
| Skim milk powder | 9.00 |
| Fresh cream 35% fat | 15.00 |
| Sugar | 3.00 |
| Spray-dried glucose syrup | 4.50 |
| Cremodan 809 Creamline | 0.60 |
| Fructose | 5.00 |
| Polydextrose Litesse Ultra | 4.00 |
| Flavour | 0.05 |
| Added sugars (%) | 9.75 |
| Total Solids (%) | 31.46 |
| Total sugars (%) | 14.45 |
| Total digestible | 17.71 |
| carbohydrates (%) | |
| Non digestible | 3.74 |
| carbohydrates (%) | |
| Protein (%) | 3.43 |
| Fat (%) | 5.79 |
| MSNF (%) | 8.48 |
| Energy (kcal/100 g) | 125 |

The ingredients are dispersed under shear in a mixing tank at 65° C. and hydrated at 60° C. during 20 minutes. Then they were pasteurized at 86° C. during 30 s and then cooled down to 72° C. They were homogenized at 150 bars and 50 bars and quickly cooled down to 4° C.

The mix was then aged for duration of minimum 4 h at 4° C. The mix was then aerated till a 100% overrun and frozen to a temperature of around −5.5° C. The ice cream produced was then hardened at −40° C. for 3 h. Samples were then stored at −30° C.

### Example 2

A water ice has been prepared using the following ingredients:

Formula 2:
Ingredients are given per % wt of total composition

| | |
|---|---|
| Water | 86.5 |
| Sugar | 7 |
| Fructose | 5 |
| Citric acid | 0.2 |
| Guar | 0.2 |
| Flavour | 0.1 |
| Added sugars | 13 |
| TS (%) | 13.4 |
| Total sugars (%) | 13 |
| Total digestible CHO (%) | 13 |
| Non digestible | 0.2 |
| carbohydrates (%) | |
| Protein (%) | 0 |
| Fat (%) | 0 |
| MSNF (%) | 0 |
| Energy (kcal/100 g) | 52 |

Mixing and pasteurization were similar to that of formula 1 in example 1. Aging is optional.

Freezing was made without aeration to a temperature of −2° C., the mix was then poured into moulds. The moulds were placed in a brine tank cooled at −40° C. for duration of 2 h and then stored at −30° C.

1. A reduced sugar ice confection composition that is free of intense sweetener, having a sugar content not exceeding 15 wt.-% based on the total composition, comprising:
a mixture of sugars containing fructose and at least 1 wt.-% of sucrose based on the total composition, the amount of fructose being up to 80% of the total sugars;
non-fat milk solids comprising not more than 8 wt % of the total composition,
less than 7 wt.-% of medium to high glycemic index oligosaccharides and/or polysaccharides;
less than 2 wt.-% polyol; and
at least a galactomannan stabilizer.

2. A reduced sugar ice confection composition that is free of intense sweetener, having a sugar content not exceeding 15 wt.-% based on the total composition, comprising:
a mixture of sugars containing fructose and at least 1 wt.-% of sucrose based on the total composition, the amount of fructose being up to 75% of the added sugars;
non-fat milk solids comprising not more than 8 wt % of the total composition;
less than 7 wt.-% of medium to high glycemic index oligosaccharides and/or polysaccharides; and
less than 2 wt.-% polyol.

3. The composition according to claim 1 wherein the amount of fructose is less than 75% of the total sugars.

4. The composition according to claim 1 wherein the amount of fructose is in a range of 2 to 10 wt.-% based on the total composition.

5. The composition according to claim 1 wherein the amount of fructose is in the range of 4 to 8 wt.-% based on the total composition.

6. The composition according to claim 1 wherein the fat content is no more than 7 wt.-% based on the total composition.

7. The composition according to claim 6 wherein the fat ingredients are selected from the group consisting of: butterfat, cream, cocoa butter, coconut oil, palm oil, palm kernel oil, sunflower oil, safflower oil, rapeseed oil, soybean oil, fractions and mixtures thereof.

8. The composition according to claim 1 further comprising digestible low glycemic index oligosaccharides and/or polysaccharides.

9. The composition according to claim 8 wherein the low glycemic index oligosaccharides and/or polysaccharides are selected from the group consisting of: slowly digestible starches and derivatives thereof.

10. The composition according to claim 8 wherein the amount of low glycemic index oligosaccharides and/polysaccharides is no more than 15 wt.-% based on the total composition.

11. The composition according to claim 1 comprising non-digestible carbohydrates.

12. The composition according to claim 11 wherein the non-digestible carbohydrates are selected from the group consisting of: inulin, fructo-oligo-saccharides, galacto-oligo-saccharides, polydextrose, dextrins, resistant starch, fibers from vegetal origin and mixtures thereof.

13. The composition according to claim 11 wherein the non-digestible carbohydrates are present in an amount of 1 to 15 wt.-% based on the total composition.

14. The composition according to claim 1 comprising ingredients selected from the group consisting of: proteins, emulsifiers, stabilizers, acidifying agents, flavourings, colourings and mixtures thereof.

15. The composition according to claim 1 further comprising an ingredient selected from the group consisting of: fruit purees, fruit pieces and juices.

16. The composition according to claim 1 wherein the water content is in the range of 55 to 95 wt.-%.

17. The composition according to claim 1, wherein the water content is at least 64 wt.-%.

18. The composition according to claim 1 having an overrun in the range of 0 to 200%.

19. The composition according to claim 2 having an overrun in the range of 20 to 250%.

20. The composition according to claim 1 which is frozen.

21. The composition according to claim 2 wherein the amount of fructose is in a range of 2 to 10 wt.-% based on the total composition.

22. The composition according to claim 21 wherein the amount of fructose is in the range of 4 to 8 wt.-% based on the total composition.

23. The composition according to claim 2 wherein the fat content is no more than 7 wt.-% based on the total composition.

24. The composition according to claim 23 wherein the fat ingredients are selected from the group consisting of: butterfat, cream, cocoa butter, coconut oil, palm oil, palm kernel oil, sunflower oil, safflower oil, rapeseed oil, soybean oil, fractions and mixtures thereof.

25. The composition according to claim 2 further comprising digestible low glycemic index oligosaccharides and/or polysaccharides.

26. The composition according to claim 25 wherein the low glycemic index oligosaccharides and/or polysaccharides are selected from the group consisting of: slowly digestible starches and derivatives thereof.

27. The composition according to claim 25 wherein the amount of low glycemic index oligosaccharides and/polysaccharides is no more than 15 wt.-% based on the total composition.

28. The composition according to claim 2 comprising non-digestible carbohydrates.

29. The composition according to claim 28 wherein the non-digestible carbohydrates are selected from the group consisting of: inulin, fructo-oligo-saccharides, galacto-oligo-saccharides, polydextrose, dextrins, resistant starch, fibers from vegetal origin and mixtures thereof.

30. The composition according to claim 28 wherein the non-digestible carbohydrates are present in an amount of 1 to 15 wt.-% based on the total composition.

31. The composition according to claim 2 comprising ingredients selected from the group consisting of: proteins, emulsifiers, stabilizers, acidifying agents, flavourings, colourings and mixtures thereof.

32. The composition according to claim 2 further comprising an ingredient selected from the group consisting of: fruit purees, fruit pieces and juices.

33. The composition according to claim 2 wherein the water content is in the range of 55 to 95 wt.-%.

34. The composition according to claim 33, wherein the water content is at least 64 wt.-%.

35. The composition according to claim 2 having an overrun in the range of 0 to 200%.

36. The composition according to claim 2 which is frozen.
